(19) United States
(12) Patent Application Publication
(10) Pub. No.: US 2015/0063463 A1
(43) Pub. Date: Mar. 5, 2015

(54) METHOD AND DEVICE FOR CODING MULTI-LAYER VIDEO, AND METHOD AND DEVICE FOR DECODING MULTI-LAYER VIDEO

(71) Applicant: SAMSUNG ELECTRONICS CO., LTD., Suwon-si (KR)

(72) Inventors: Byeong-doo Choi, Siheung-si (KR); Young-o Park, Seoul (KR); Jae-hyun Kim, Seoul (KR); Jeong-hoon Park, Seoul (KR)

(73) Assignee: SAMSUNG ELECTRONICS CO., LTD., Suwon-si (KR)

(21) Appl. No.: 14/394,644

(22) PCT Filed: Apr. 15, 2013
(86) PCT No.: PCT/KR2013/003154

§ 371 Date: Oct. 15, 2014

Related U.S. Application Data
(60) Provisional application No. 61/624,311, filed on Apr. 15, 2012.

(51) Int. Cl. H04N 19/30; H04N 19/44

(52) U.S. Cl. CPC H04N 19/30; H04N 19/44
USPC 375/240.25

(57) ABSTRACT

A multi-layer video decoding method includes receiving a plurality of multi-layer image streams that constitute a multi-layer video, obtaining, from a data unit header including information of a second random access point (RAP) picture that corresponds to a first RAP picture included in a first layer image stream and is included in a second layer image stream from among the plurality of multi-layer image streams, first picture order count (POC) information for determining a first partial value of a POC of the second RAP picture that is set to be the same as a POC of the first RAP picture, obtaining, from the data unit header, second POC information about a second partial value of the POC of the second RAP picture, and obtaining the POC of the second RAP picture by using the first POC information and the second POC information.

### CROSS-REFERENCE TO RELATED APPLICATIONS

This application is a National Stage Entry of PCT/KR2013/003154, filed on Apr. 15, 2013, which claims priority to U.S. provisional patent application No. 61/624,311, filed on Apr. 15, 2012 in the U.S. Patent and Trademark Office, the entire disclosures of which are incorporated herein by reference in their entirety.

### TECHNICAL FIELD

Apparatuses and methods consistent with exemplary embodiments relate to video encoding and decoding, and more particularly, to a high level syntax structure of picture order count (POC) information of a random access point (RAP) picture that is included in a multi-layer video.

### BACKGROUND OF THE RELATED ART

Image data is encoded by a codec according to a predetermined compression standard, for example, a moving picture expert group (MPEG) standard, and then is stored as a bitstream in an information storage medium or is transmitted through a communication channel.

Scalable video coding (SVC) is a video compression method for adjusting the amount of information to be suitable for various communication networks and terminals and transmitting the adjusted information. In SVC, images of a base layer and an enhancement layer that support adaptive service are provided to various transmission networks and various receiving terminals.

As three-dimensional (3D) multimedia devices and 3D multimedia content have recently been developed, a multi-view video coding technology for 3D video coding has been widely used.

When a multi-layer video is encoded in, for example, SVC or multi-view video coding, there is a demand for an efficient encoding method for reducing the amount of data of the multi-layer video. Also, there is a demand to synchronize corresponding images of layers that are included in the multi-layer video.

### SUMMARY

The exemplary embodiments provide a method of efficiently signaling picture order count (POC) information that is used to encode and decode a multi-layer video.

Also, the exemplary embodiments synchronize layer images by enabling corresponding random access point (RAP) pictures included in multiple layers to maintain the same POC even during interlayer switching or interlayer random access.

According to an aspect of an exemplary embodiment, there is provided a multi-layer video decoding method including: receiving a plurality of multi-layer image streams that constitute a multi-layer video; obtaining, from a data unit header including information of a second random access point (RAP) picture that corresponds to a first RAP picture included in a first layer image stream, which is a base layer from among the plurality of multi-layer image streams, and is included in a second layer image stream from among the plurality of multi-layer image streams, first picture order count (POC) information for determining a first partial value of a POC of the second RAP picture that is set to be the same as a POC of the first RAP picture; obtaining, from the data unit header, second POC information about a second partial value of the POC of the second RAP picture; and obtaining the POC of the second RAP picture by using the obtained first POC information and the obtained second POC information.

The POC of the first RAP picture may indicate a display order of the first RAP picture based on a previous instantaneous decoding refresh (IDR) picture, and when a binary value corresponding to the POC of the first RAP picture includes m (m is an integer) upper bits and n (n is an integer) lower bits, the first POC information is information about the m upper bits and the second POC information is information about the n lower bits.

The POC of the first RAP picture may indicate a display order of the first RAP picture based on an instantaneous decoding refresh (IDR) picture that precedes the first RAP picture, and when a binary value corresponding to the POC of the first RAP picture includes m (m is an integer) upper bits and n (n is an integer) lower bits and 2ⁿ orders that may be expressed by using the n lower bits are defined as one cycle, when the first RAP picture is displayed at a x*(2ⁿ)th numerical position (x is an integer) or a {(x+1)*(2ⁿ)−1}th numerical position based on the IDR picture, the first POC information is a value of x indicating a number of repetitions of the one cycle and the second POC information is information about the n lower bits.

The obtaining of the first POC information may include obtaining, from the data unit header, a flag indicating whether the first POC information is to be used, and when the obtained flag indicates that the first POC information is to be used, obtaining the first POC information.

The first and second RAP pictures may each be a clean random access (CRA) picture or a broken link access (BLA) picture.

The data unit header may be one selected from a sequence parameter set (SPS), a picture parameter set (PPS), an adaptation parameter set (APS), and a slice header.

The multi-layer video decoding method may further include determining whether a picture loss occurs in the plurality of multi-layer image streams by setting the POC of the first RAP picture that is obtained by using the first POC information and the second POC information obtained from the data unit header and a POC of an instantaneous decoding refresh (IDR) picture that precedes the first RAP picture to 0, increasing the POC set to 0 by 1 for each picture that is displayed after a previous IDR picture, and comparing obtained POCs of the first RAP picture.

According to another aspect of an exemplary embodiment, there is provided a multi-layer video decoding apparatus including a receiver configured to receive a plurality of multi-layer image streams that constitute a multi-layer video, obtain, from a data unit header including information of a second random access point (RAP) picture that corresponds to a first RAP picture included in a first layer image stream, which is a base layer from among the plurality of multi-layer image streams, and is included in a second layer image stream from among the plurality of multi-layer image streams, first picture order count (POC) information for determining a first partial value of a POC of the second RAP picture that is set to be the same as a POC of the first RAP picture and second POC information about a second partial value of the POC of the second RAP picture, and obtain the POC of the second RAP picture by using the obtained first POC information and the obtained second POC information; and a multi-layer decoder configured to decode the plurality of multi-layer image streams.

According to another aspect of an exemplary embodiment, there is provided a multi-layer video encoding method including encoding a plurality of multi-layer images that constitute a multi-layer video and generating a plurality of multi-layer image streams based on the encoded plurality of multi-layer images; adding, to a data unit header including information of a second random access point (RAP) picture that corresponds to a first RAP picture included in a first layer image stream, which is a base layer from among the plurality of multi-layer image streams, and is included in a second layer image stream from among the plurality of multi-layer image streams, first picture order count (POC) information for determining a first partial value of a POC of the second RAP picture that is set to be the same as a POC of the first RAP picture; and adding second POC information about a second partial value of the POC of the second RAP picture to the data unit header.

The POC of the first RAP picture may indicate a display order of the first RAP picture based on an instantaneous decoding refresh (IDR) picture that precedes the first RAP picture, and when a binary value corresponding to the POC of the first RAP picture includes m (m is an integer) upper bits and n (n is an integer) lower bits, the first POC information is information about the m upper bits and the second POC information is information about the n lower bits.

The POC of the first RAP picture may indicate a display order of the first RAP picture based on an instantaneous decoding refresh (IDR) picture that precedes the first RAP picture, and when a binary value corresponding to the POC of the first RAP picture includes m (m is an integer) upper bits and n (n is an integer) lower bits and 2ⁿ orders are defined as one cycle, when the first RAP picture is displayed at a x*(2ⁿ)th numerical position (x is an integer) or a {(x+1)*(2ⁿ)−1}th numerical position, the first POC information is a value of x indicating a number of repetitions of the one cycle and the second POC information is information about the n lower bits.

The first and second RAP pictures may each be a clean random access (CRA) picture or a broken link access (BLA) picture.

The data unit header may be one selected from a sequence parameter set (SPS), a picture parameter set (PPS), an adaptation parameter set (APS), and a slice header.

According to another aspect of an exemplary embodiment, there is provided a multi-layer video encoding apparatus including a multi-layer image encoder configured to encode a plurality of multi-layer images that constitute a multi-layer video and generate a plurality of multi-layer image streams based on the encoded plurality of multi-layer images; and an outputter configured to add first picture order count (POC) information for determining a first partial value of a POC of a second random access point (RAP) picture that is set to be the same as a POC of a first RAP picture to a data unit header including information of the second RAP picture that corresponds to the first RAP picture included in a first layer image stream, which is a base layer from among the plurality of multi-layer image streams, and is included in a second layer image stream from among the plurality of multi-layer image streams, and add second POC information about a second partial value of the second RAP picture to the data unit header.

According to another aspect of an exemplary embodiment, there is provided a method of determining an image order of a multi-layer video, the method including obtaining, from a header of a data unit including information of a random access point (RAP) picture included in the multi-layer video, information about upper bits of a picture order count (POC) of the RAP picture and information about lower bits of the POC; and determining the POC of the RAP picture based on the obtained information about the upper bits and the obtained information about the lower bits.

According to exemplary embodiments, synchronization between layers during reproduction of a multi-layer video signal may be achieved by signaling a picture order count (POC) of a random access point (RAP) picture that is decoded during interlayer switching or random access. Also, according to the exemplary embodiments, a receiver of the multi-layer video signal may determine whether a frame loss occurs or an error occurs by using POC information of the RAP picture.

### BRIEF DESCRIPTION OF THE DRAWINGS

FIG. 1 is a diagram for explaining a picture order count (POC) of a picture of a first layer that is included in a multi-layer video and a relationship between first layer POC_MSBs and first layer POC_LSBs obtained by classifying the POC of the picture of the first layer;

FIG. 2 is a diagram illustrating a configuration of a multi-layer video encoding apparatus according to an exemplary embodiment;

FIG. 3 is a diagram illustrating a network abstraction layer (NAL) unit according to an exemplary embodiment;

FIGS. 4 and 5 are diagrams illustrating a type of a NAL unit according to a value of an identifier nal_unit_type of the NAL unit, according to an exemplary embodiment;

FIG. 6 is a diagram illustrating slice header information of a clean random access (CRA) picture that is included in a NAL unit and is transmitted, according to an exemplary embodiment;

FIG. 7 is a diagram illustrating slice header information of a CRA picture that is included in a NAL unit and is transmitted, according to another exemplary embodiment;

FIG. 8 is a flowchart illustrating a multi-layer video encoding method according to an exemplary embodiment;

FIG. 9 is a diagram illustrating a configuration of a multi-layer video decoding apparatus according to an exemplary embodiment;

FIG. 10 is a flowchart illustrating a multi-layer video decoding method according to an exemplary embodiment;

FIG. 11 is a flowchart illustrating a method of determining an image order of a multi-layer video, according to an exemplary embodiment;

FIG. 12 is a block diagram of a video encoding apparatus that performs video prediction based on coding units having a tree structure, according to an exemplary embodiment;

FIG. 13 is a block diagram of a video decoding apparatus that performs video prediction based on coding units having a tree structure, according to an exemplary embodiment;

FIG. 14 is a diagram for explaining a concept of coding units according to an exemplary embodiment;

FIG. 15 is a block diagram of an image encoder configured to perform an encoding operation based on coding units, according to an exemplary embodiment;

FIG. 16 is a block diagram of an image decoder configured to perform a decoding operation based on coding units, according to an exemplary embodiment;

FIG. 17 is a diagram illustrating deeper coding units according to depths and partitions, according to an exemplary embodiment;

FIG. 18 is a diagram for explaining a relationship between a coding unit and transformation units, according to an exemplary embodiment;

FIG. 19 is a diagram for explaining encoding information of coding units corresponding to a coded depth, according to an exemplary embodiment;

FIG. 20 is a diagram of deeper coding units according to depths according to an exemplary embodiment;

FIGS. 21, 22, and 23 are diagrams for explaining a relationship between coding units, prediction units, and transformation units, according to an exemplary embodiment; and

FIG. 24 is a diagram for explaining a relationship between a coding unit, a prediction unit, and a transformation unit, according to encoding mode information of Table 1.

### DETAILED DESCRIPTION OF THE EXEMPLARY EMBODIMENTS

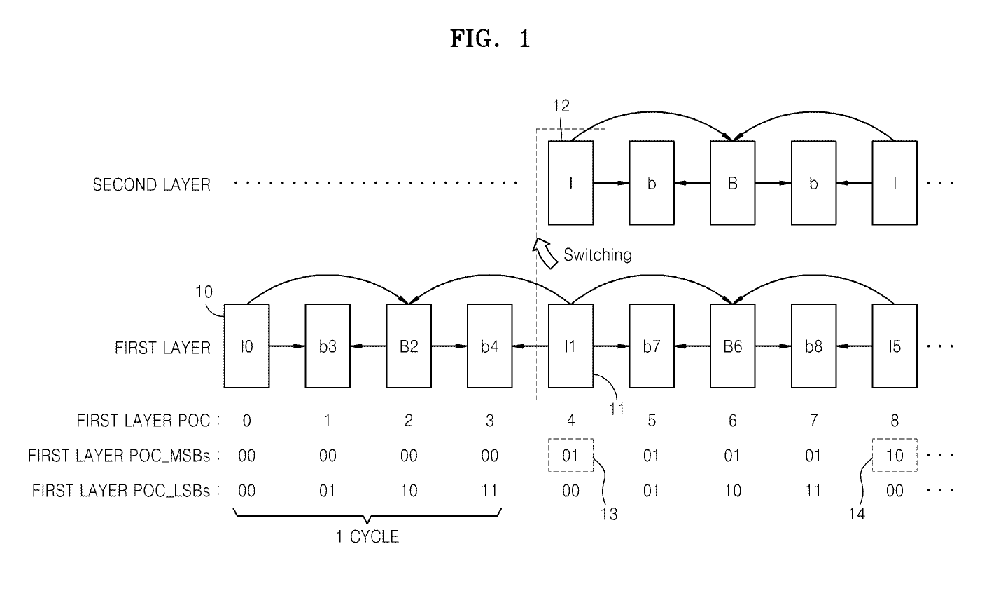

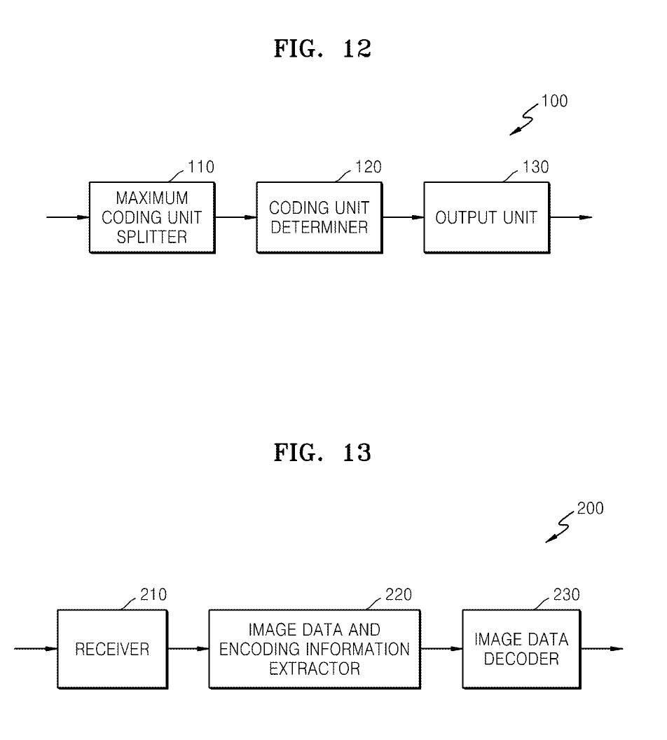

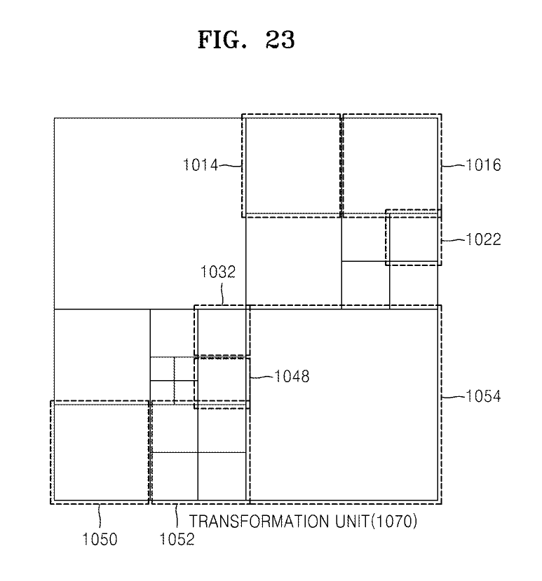

A multi-layer video encoding apparatus and a multi-layer video decoding apparatus, and a multi-view video encoding method and a multi-view video decoding method according to an exemplary embodiment will be described with reference to FIGS. 1 through 11. Also, a video encoding apparatus and a video decoding apparatus, and a video encoding method and a video decoding method to perform encoding and decoding operations based on coding units having a tree structure according to an exemplary embodiment will be described with reference to FIGS. 12 through 24. Hereinafter, a multi-layer video may refer to a video having a plurality of layers such as a multi-view video, a scalable video, or a three-dimensional (3D) video.

Data that is encoded in a video encoding apparatus is transmitted to a video decoding apparatus by using a transmission data unit that is appropriate for a format or a protocol of a communication channel, a storage medium, a video editing system, or a media framework.

The video decoding apparatus may restore and reproduce video data according to one of a trick play method and a normal play method when the video data is to be reproduced. The trick play method includes a random access method. The normal play method is a method of sequentially processing and reproducing all pictures that are included in the video data. The random access method is a method of performing reproduction beginning from a random access point (RAP) picture that may be independently restored. According to a related art H.264 standard, only an instantaneous decoder refresh (IDR) picture is used as the RAP picture. The IDR picture is a picture that includes only an I slice that refreshes a decoding apparatus the instant a corresponding picture is decoded. In detail, the instant the IDR picture is decoded, a decoded picture buffer (DPB) marks a picture that is previously decoded other than the IDR picture as a picture that is unused for reference, and a picture order count (POC) is also initialized. Also, a picture that is decoded after the IDR picture is behind the IDR picture in terms of a display order, and a picture prior to the IDR picture may be encoded without reference.

According to an exemplary embodiment, a clean random access (CRA) picture and a broken link access (BLA) picture, instead of the IDR picture, may be used as the RAP picture. The CRA picture that is a picture including only an I slice refers to a picture including pictures that are encoded earlier in a display order than the CRA picture but is encoded later in an encoding order than the CRA picture. A picture that is encoded earlier in a display order than the CRA picture but is encoded later in an encoding order than the CRA picture is defined as a leading picture. The BLA picture is a picture obtained by subdividing the CRA picture according to a splicing position. The CRA picture may be classified as the BLA picture according to whether the CRA picture includes a leading picture and whether the CRA picture includes a random access decidable leading (RADL) picture or a random access skip leading (RASL) picture. Since a method of processing the BLA picture is basically the same as a method of processing the CRA picture, the following will focus on a case where the CRA picture is used as the RAP picture. A decoding order and an encoding order respectively refer to orders in which a decoding apparatus and an encoding apparatus process pictures. Since the encoding apparatus sequentially encodes and outputs pictures according to an order in which the pictures are input, and the decoding apparatus decodes the encoded pictures according to an order in which the encoded pictures are received, the encoding order of the pictures is the same as the decoding order.

Both the IDR picture and the CRA picture are the RAP pictures that may be encoded without referring to other pictures. However, there is no picture that trails the IDR picture in an encoding order and precedes the IDR picture in a display order. However, there is a leading picture that trails the CRA picture in an encoding order and precedes the CRA picture in a display order.

Since the POC that indicates a display order of each picture based on the IDR picture is used to determine a point of time when an encoded picture is output and to determine a reference picture set that is used for prediction encoding of each picture, POC information of each picture is important during video processing.

The POC is reset to 0 the instant the IDR picture is decoded, and pictures that are displayed after the IDR picture until a next IDR picture is decoded have POCs that are increased by +1. There is an explicit method of signalling a POC. The explicit method refers to a method that involves classifying a POC into most significant bits (MSBs) including predetermined m (m is an integer) upper bits and least significant bits (LSBs) including predetermined n (n is an integer) lower bits and transmitting the LSBs as POC information of each picture. A decoder may obtain MSBs of a POC of a current picture based on information about MSBs of a POC of a previous picture and received information about LSBs of the POC of the current picture.

FIG. 1 is a diagram for explaining a POC of a picture of a first layer that is included in a multi-layer video and a relationship between first layer POC_MSBs and first layer POC_LSBs obtained by classifying the POC of the picture of the first layer. In FIG. 1, an arrow denotes a reference direction. Also, I# denotes an I picture that is decoded at a #th numerical position, and b# or B# denotes a B picture that is decoded at a #th numerical position that is bidirectional-predicted by referring to a reference picture according to the arrow. For example, a B2 picture is decoded by referring to an I0 picture and an I1 picture.

Referring to FIG. 1, pictures of a first layer are decoded in an order of I0, I1, B2, b3, b4, 15, B6, b7, and b8. The pictures of the first layer are displayed in an order of I0, b3, B2, b4, I1, b7, B6, b8, and 15. POC information of the pictures of the first layer has to be signaled in order to determine a display order that is different from a decoding order. As described above, in an explicit mode, a POC may be classified into MSBs including upper bits and LSBs including lower bits, and only the LSBs including the lower bits may be transmitted as POC information.

An I0 picture 10 is a picture that is first decoded from among the pictures of the first layer and is an IDR picture. As described above, since a POC is reset to 0 the instant the IDR picture is decoded, the I0 picture 10 has a POC that is 0. Assuming that a number of bits of LSBs of a POC is 2 bits, the LSBs of the pictures that are included in the first layer are formed such that “00 01 10 11” is repeated as shown in FIG. 1. When one cycle of “00 01 10 11” that may be expressed by using lower bits is completed, the MSBs of the POC are increased by +1. Even when only information of the LSBs of the POC is received, a decoding apparatus may obtain the MSBs of the POC of the pictures of the first layer by increasing by +1 a value of the MSBs of the POC when one cycle of the pictures that are displayed during a decoding process is completed. Also, the decoding apparatus may restore the POC of each picture by using the MSBs and the LSBs. For example, a process of restoring a POC of an I1 picture 11 will be described. Information “00” of LSBs of a POC is obtained through a predetermined data unit for the I1 picture 11. Since a value of LSBs of a POC of a previous picture b4 that is displayed prior to the I1 picture 11 is “11” and a value of the LSBs of the POC of the I1 picture 11 is “00”, “01” 13 may be obtained as a value of MSBs of the POC of the I1 picture 11 by increasing a value of MSBs of the POC of the previous picture b4 by +1. Once the MSBs and the LSBs are obtained, a binary value “0100” corresponding to 4 that is a POC value of the I1 picture 11 may be obtained through MSBs+LSBs.

As such, there is little difficulty in a uni-layer video to transmit only LSBs information of a POC. However, when interlayer random access or interlayer switching occurs in a multi-layer video, POC asynchronization between pictures of layers may be caused. For example, it is assumed that random access or interlayer switch occurs in an image of a second layer while an image of a first layer is reproduced, and thus reproduction is performed beginning from an I picture 12 that is a RAP picture of the second layer. The decoding apparatus resets MSBs of a POC of the I picture 12 of the second layer that is first decoded through random access. Accordingly, a POC of the I picture 11 of the first layer includes MSBs of “01” 13 whereas the POC of the I picture 12 of the second layer includes MSBs that are reset to “00” due to the random access. Accordingly, the I picture 11 of the first layer and the I picture 12 of the second layer that have to be displayed at the same time have different POCs and a display order of an image of the first layer and a display order of an image of the second layer may be different from each other.

Accordingly, according to an exemplary embodiment, even when interlayer random access or interlayer switching by which a reproduced layer is changed occurs in a multi-layer video, not only LSBs information of a POC of a CRA picture and a BLA picture from among RAP pictures but also MSBs information of the POC are transmitted to synchronize pictures of layers that have to be displayed at the same time. In an IDR picture, both MSBs and LSBs of a POC are reset to 0 and a POC value is 0. Accordingly, when a picture of one layer that is included in the same access unit is an IDR picture, an encoder may set corresponding pictures of other layers to IDR pictures, thereby making it unnecessary to transmit additional POC information of the IDR pictures. When interlayer random access occurs and reproduction is performed beginning from IDR pictures from among RAP pictures, since POC values of the IDR pictures are set to 0, the IDR pictures between layers have the same POC value, thereby leading to synchronization.

FIG. 2 is a diagram illustrating a configuration of a multi-layer video encoding apparatus 20 according to an exemplary embodiment.

Referring to FIG. 2, the multi-layer video encoding apparatus 20 according to an exemplary embodiment includes a multi-layer encoder 21 and an output unit 24 (e.g., outputter).

The multi-layer encoder 21 corresponds to a video coding layer. The output unit 24 corresponds to a network abstraction layer (NAL) that generates transmission unit data according to a predetermined format from encoded multi-layer video data and additional information. According to an exemplary embodiment, the transmission unit data may be a NAL unit. Also, POC information of a CRA picture and a BLA picture may be included in any one selected from a sequence parameter set (SPS), a picture parameter set (PPS), an adaptation parameter set (APS), and a slice header. Header information of a predetermined data unit including the POC information of the CRA picture and the BLA picture may be included in a NAL unit including a predetermined identifier and may be transmitted.

The multi-layer encoder 21 according to an exemplary embodiment encodes n (n is an integer) multi-layer images that constitute a multi-layer video and generates a plurality of multi-layer image streams. The multi-layer encoder 21 may include n layer encoders 22 and 23 that encode n multi-layer images. When the multi-layer images are multi-view images, the multi-layer encoder 21 encodes base view images and additional view images. For example, a central view image may be encoded as a base layer image by a first layer encoder 23, and left view images and right view images may be respectively encoded by a second layer encoder and a third layer encoder. Each view image that constitutes the n multi-view images may be encoded by the multi-layer encoder 21 and may be output as n view image streams. Also, when the multi-layer images are a multi-view color video and a depth map corresponding to the multi-view color video, the multi-layer encoder 21 may encode the multi-view color video and the depth map and may generate a multi-layer image stream. When the multi-layer images are a scalable video, the multi-layer encoder 21 may encode a base layer image and an enhancement layer image and may output a base layer image stream and an enhancement layer image stream.

The multi-layer video encoding apparatus 20 according to an exemplary embodiment may encode an image of each layer by using coding units having a hierarchical tree structure. The coding units having the tree structure may be, for example, maximum coding units, coding units, prediction units, and transformation units. Video encoding and decoding methods based on the coding units having the tree structure will be explained below with reference to FIGS. 12 through 24.

The output unit 24 adds first POC information for determining MSBs that are a first partial value of a POC of a CRA picture and second POC information for LSBs that are a second partial value to a predetermined data unit header including information of the CRA picture that is included in image streams of each layer. CRA pictures that correspond to each other in each layer of a multi-layer image have the same MSBs and LSBs in order to have the same POC value.

The output unit 24 may determine a display order of a CRA picture that is included in a first layer based on the IDR picture of the first layer. That is, the output unit 24 determines a POC of a CRA picture by determining at what numerical position the CRA picture is displayed based on an IDR picture prior to the CRA picture. Also, when a binary value corresponding to the POC of the CRA picture includes m (m is an integer) upper bits and n (n is an integer) lower bits, the output unit 24 may add first POC information that is information about the m upper bits and second POC information that is information about the n lower bits to a predetermined data unit header including information about the CRA picture. It is assumed that a value of the POC includes upper bits MSBs of 2 bits and lower bits LSBs of 2 bits. In this case, as POC information of a CRA picture that is displayed at a 7th numerical position based on an IDR picture and has a POC value of 7, a binary value “0111” corresponding to the POC value of 7 may be classified into upper two bits “01” and lower two bits “11” and information of the upper bits MSBs and the lower bits LSBs may be added to one selected from a slice header, an SPS, a PPS, and an APS including information of the CRA picture.

Also, when (2̂n) orders that may be expressed by using the n lower bits are defined as one cycle and a CRA picture is displayed at a x*(2̂n)th (x is an integer) numerical position or a {(x+1)*(2̂n)−1}th numerical position based on an IDR picture, the output unit 24 may add a value of x indicating a number of repetitions of the one cycle as first POC value to any one selected from a slice header, an SPS, a PPS, and an APS.

For a BLA picture, the output unit 24 may add first POC information for determining MSBs of a POC of the BLA picture and second POC information for LSBs to any one selected from a slice header, an SPS, a PPS, and an APS, similar to the CRA picture.

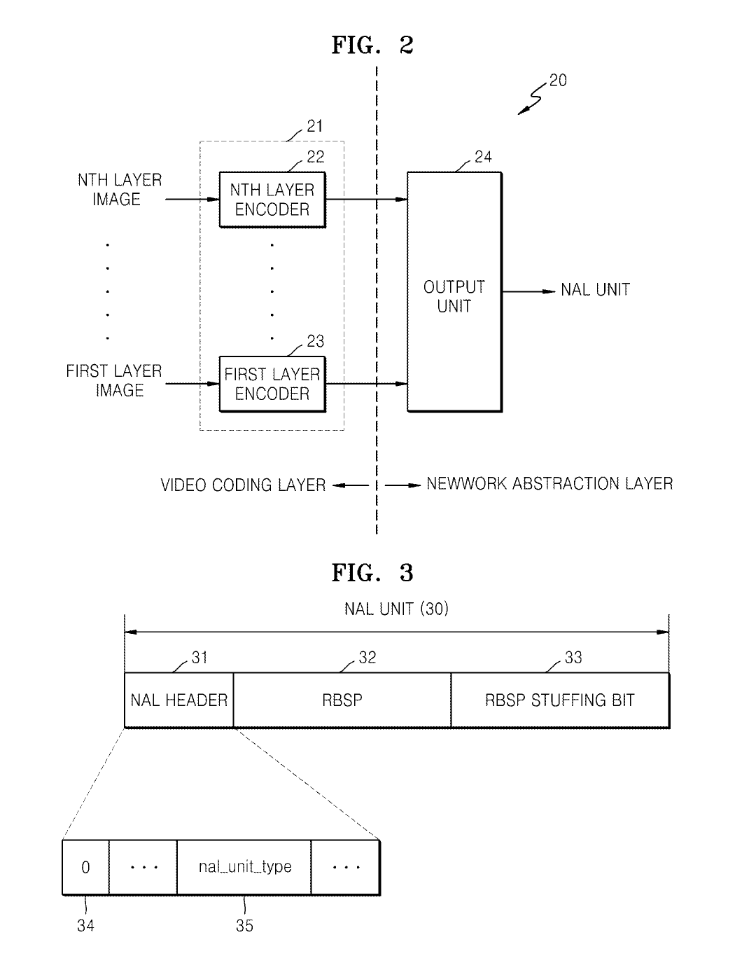

FIG. 3 is a diagram illustrating a NAL unit 30 according to an exemplary embodiment.

The NAL unit 30 includes a NAL header 31 and a raw byte sequence payload (RBSP) 32. An RBSP stuffing bit 33 is a length-adjusting bit that is attached to the rearmost of the RBSP 32 in order to represent a length of the RBSP 32 by a multiple of 8 bits. The RBSP stuffing bit 33 begins from ‘1’, continuously includes 0′ the number of which is determined according to the length of the RBSP 32, and has a pattern, for example, ‘100 . . . ’. A position of a last bit of the RBSP 32 that is placed right before the RBSP stuffing bit 33 may be determined by searching for ‘1’ that is a first bit value of the RBSP stuffing bit 33.

The NAL header 31 includes an identifier nal_unit_type 35 for identifying which information is included in the corresponding NAL unit 30 as well as forbidden_zero_bit 34 having a value of 0. POC information of a CRA picture according to an exemplary embodiment is transmitted to a NAL unit that is previously determined to include information of the CRA picture.

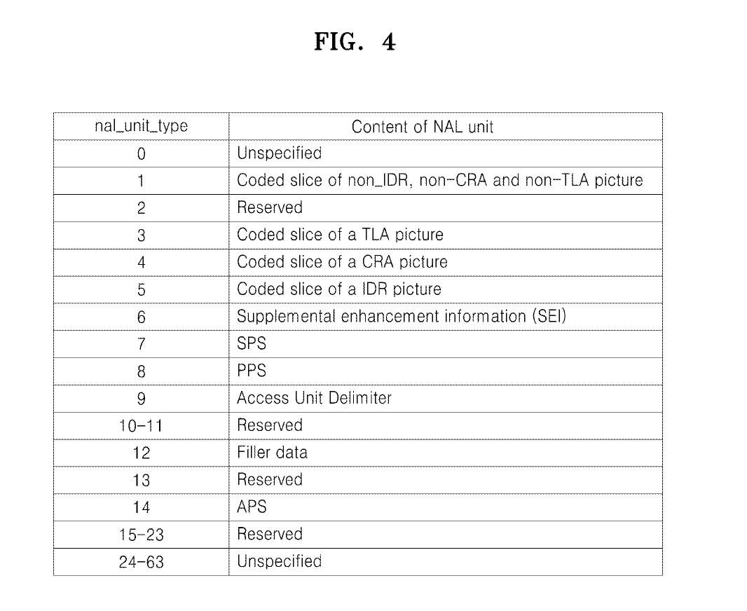

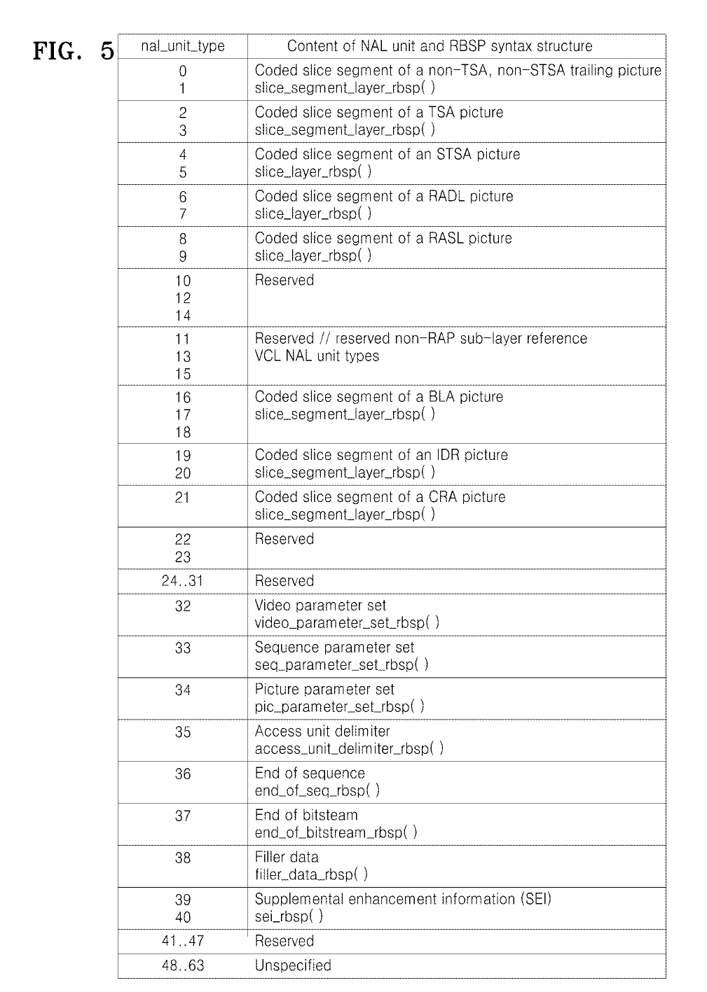

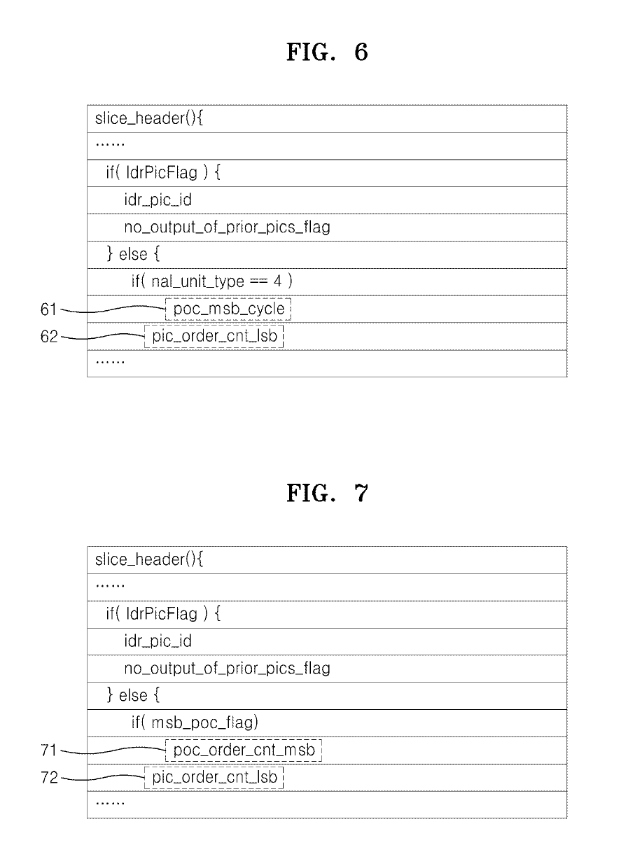

FIGS. 4 and 5 are diagrams illustrating a type of a NAL unit according to a value of an identifier nal_unit_type of the NAL unit, according to an exemplary embodiment.

Referring to FIG. 4, a NAL unit including the identifier nal_unit_type having a value of 4 may be set to have information about a CRA picture. In this case, the output unit 24 adds first POC information for determining MSBs of a POC of the CRA picture and second POC information indicating LSBs to a slice header of the CRA picture that is included in the NAL unit including the identifier nal_unit_type having the value of 4 and transmits the same. Referring to FIG. 5, a NAL unit including the identifier nal_unit_type having a value of 5 may be set to have information about a CRA picture. In this case, the output unit 254 adds first POC information for determining MSBs of a POC of the CRA picture and second POC information indicating LSBs to the NAL unit including the identifier nal_unit_type having the value of 5 and transmits the same. The present exemplary embodiment is not limited to FIGS. 4 and 5, and a value of the identifier nal_unit_type of a NAL unit having information about a CRA picture may be changed according to other exemplary embodiments.

FIG. 6 is a diagram illustrating slice header information of a CRA picture that is included in a NAL unit and is transmitted, according to an exemplary embodiment.

It is assumed that the identifier nal_unit_type having information about a CRA picture has a value of 4. When a current NAL unit has slice header information about the CRA picture, first POC information poc_msb_cycle 61 for determining MSBs of a POC of the CRA picture is included in a slice header. The first POC information poc_msb_cycle 61 may be information about m upper bits of the POC of the CRA picture. Also, when the CRA picture is displayed at a x*(2̂n)th numerical position (x is an integer) or a {(x+1)*(2̂n)−1}th numerical position based on a previous IDR picture, the first POC information poc_msb_cycle 61 may be a value of x indicating a number of repetitions of one cycle.

Second POC information pic_order_cnt_lsb 62 indicating LSBs of the POC of the CRA picture is included in the slice header.

FIG. 7 is a diagram illustrating slice header information of a CRA picture that is included in a NAL unit and is transmitted, according to another exemplary embodiment.

Referring to FIG. 7, whether to use first POC information poc_order_cnt_msb 71 may be indicated by using a predetermined flag msb_poc_flag. Only when a value of the flag msb_poc_flag is 1, a decoder may obtain the first POC information poc_order_cnt_msb 71, and when a value of the flag msb_poc_flag is 0, the first POC information of the CRA picture may not be used. The first POC information poc_order_cnt_msb 71 may be information about m upper bits of a POC of the CRA picture, or when the CRA picture is displayed at a x*(2̂n)th numerical position (x is an integer) or a {(x+1)*(2̂n)−1}th numerical position based on a previous IDR picture, may be a value of x indicating a number of repetitions of one cycle.

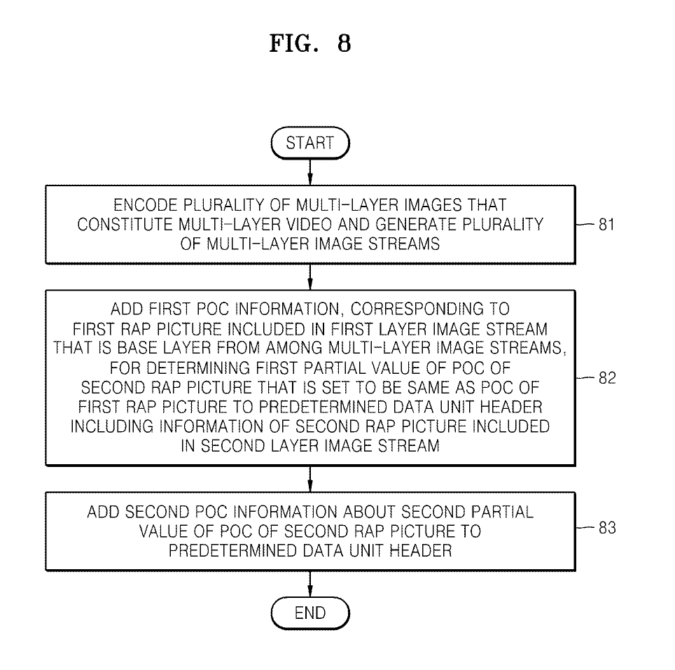

FIG. 8 is a flowchart illustrating a multi-layer video encoding method according to an exemplary embodiment.

Referring to FIGS. 2 and 8, in operation 81, the multi-layer encoder 21 encodes a plurality of multi-layer images that constitute a multi-layer video and generates a plurality of multi-layer image streams.

In operation 82, the output unit 24 adds first POC information for determining MSBs that is a first partial value of a POC of a CRA picture to a predetermined data unit header including information of the CRA picture that is included in image streams of each layer. The output unit 24 may determine the POC of the CRA picture based on an IDR picture. When a binary value corresponding to the POC of the CRA picture includes m upper bits and n lower bits, the output unit 24 may add the first POC information that is information about the m upper bits and second POC information that is information about the n lower bits to one selected from a slice header, an SPS, a PPS, and an APS.

Also, assuming that (2̂n) orders that may be expressed by using the n lower bits is defined as one cycle, when the CRA picture is displayed at a x*(2̂n)th numerical position (x is an integer) or a {(x+1)*(2̂n)−1}th numerical position based on an IDR picture, the output unit 24 may add a value of x indicating a number of repetitions of the one cycle as the first POC information to one selected from a slice header, an SPS, a PPS, and an APS.

In operation 83, the output unit 24 may add second POC information indicating LSBs that are the lower n bits of the POC of the CRA picture to one selected from a slice header, an SPS, a PPS, and an APS including information about the CRA picture.

The first POC information and the second POC information of CRA pictures that correspond to each other in each layer have the same values so that the corresponding CRA pictures of each layer have the same POC.

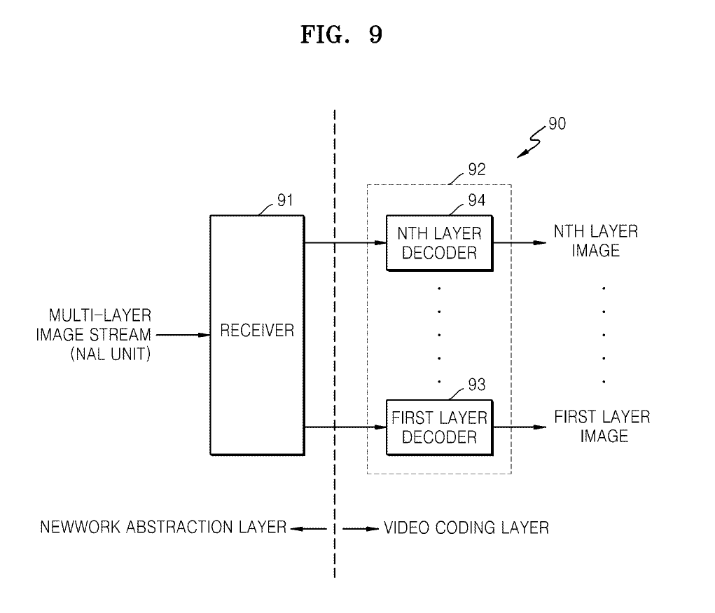

FIG. 9 is a diagram illustrating a configuration of a multi-layer video decoding apparatus 90 according to an exemplary embodiment.

Referring to FIG. 9, the multi-layer video decoding apparatus 90 according to an exemplary embodiment includes a receiver 91 and a multi-layer decoder 92.

The receiver 91 receives a plurality of multi-layer image streams that constitute an encoded multi-layer video. The multi-layer image streams may be received in units of NALs. The receiver 91 obtains first POC information for determining MSBs of a POC of a RAP picture and second POC information for determining LSBs of the POC of the RAP picture from a predetermined data unit header including information of the RAP picture of each layer. As described above, the RAP picture may be a CRA picture or a BLA picture.

In detail, when a binary value corresponding to the POC of the CRA picture includes MSBs that are m upper bits and LSBs that are n lower bits, the receiver 910 may read first POC information about the MSBs and second POC information about the LSBs from a predetermined data unit header including information about the CRA picture. As described above, the data unit header may be one selected from a slice header, an SPS, a PPS, and an APS including information about the CRA picture.

The receiver 91 may restore the POC of the CRA picture through MSBs+LSBs when information about the MSBs and the LSBs of the POC of the CRA picture is obtained.

Assuming that the CRA picture is displayed at a x*(2̂n)th numerical position (x is an integer) or a {(x+1)*(2̂n)−1}th numerical position based on an IDR picture and a value of x indicating a number of repetitions of one cycle is transmitted as first POC information, when a size of the one cycle is MaxPicOrderCntLsb, MSBs information of the POC may be obtained by calculating a value of x*MaxPicOrderCntLsb. As in the previous exemplary embodiment, when n lower bits are used, MaxPicOrderCntLsb is (2̂n), and a value of x indicating a number of repetitions of a cycle is transmitted as first POC information, MSBs of the POC may be restored through x*(2̂n).

According to an exemplary embodiment, even when interlayer switching or random access to a second layer image occurs while a first layer image stream that is a base layer is decoded, since a POC of a RAP picture of each layer may be restored, pictures that correspond to each other in each layer may maintain the same POC.

When MSBs of a POC of a CRA picture or a BLA picture that is currently decoded are not received due to a transmission error or the like, the receiver 91 may derive the MSBs of the POC of the current CRA picture or the BLA picture from an MSB value of a POC of a previous picture that is previously displayed. For example, referring to FIG. 1, when MSBs of a POC of the I1 picture 11 are not transmitted due to a transmission error or the like, since a value of LSBs of a POC of a previous picture b4 that is previously displayed is “11” and a value of LSBs of the POC of the I1 picture 11 is “00” corresponding to the last periodic value from among periodic values of LSBs, the receiver 91 may obtain “01” 13 as the value of the MSBs of the POC of the I1 picture 11 by increasing the value of the MSBs of the POC of the previous picture b4 by +1. If the MSBs of the POC may not be derived from a previous picture through random access or interlayer switching, the receiver 91 may set the MSBs of the POC of the CRA picture or the BLA picture that is currently decoded to a preset initial value, for example, 0.

The multi-layer decoder 92 decodes the plurality of multi-layer image streams. The multi-layer decoder 92 may include n layer decoders 93 and 94 that decode n multi-layer images. When the multi-layer images are multi-view images, the multi-layer decoder 92 decodes base view images and additional view images. When the encoded multi-layer images include n multi-view images, the multi-layer decoder 92 decodes n view images. Also, when the encoded multi-layer images are a multi-view color video and a depth map corresponding to the multi-view color video, the multi-layer decoder 92 decodes and outputs the multi-view color video and the depth map. When the encoded multi-layer images are a scalable video, the multi-layer decoder 92 decodes and outputs a base layer image and an enhancement layer image.

The receiver 91 may determine whether a picture loss occurs in the multi-layer image streams by setting a POC of a RAP picture that is obtained by using the obtained first POC information and the second POC information and a POC of an IDR picture that precedes the RAP picture to 0, increasing the POC by 1 for each picture that is displayed after the previous IDR picture, and comparing obtained POCs of the RAP picture. That is, when the POC of the RAP picture that is obtained based on the first POC information and the second POC information of the current RAP picture is different from a value obtained by increasing by 1 a POC of a picture that is previously displayed, the receiver 91 may determine that a picture loss occurs in the RAP picture.

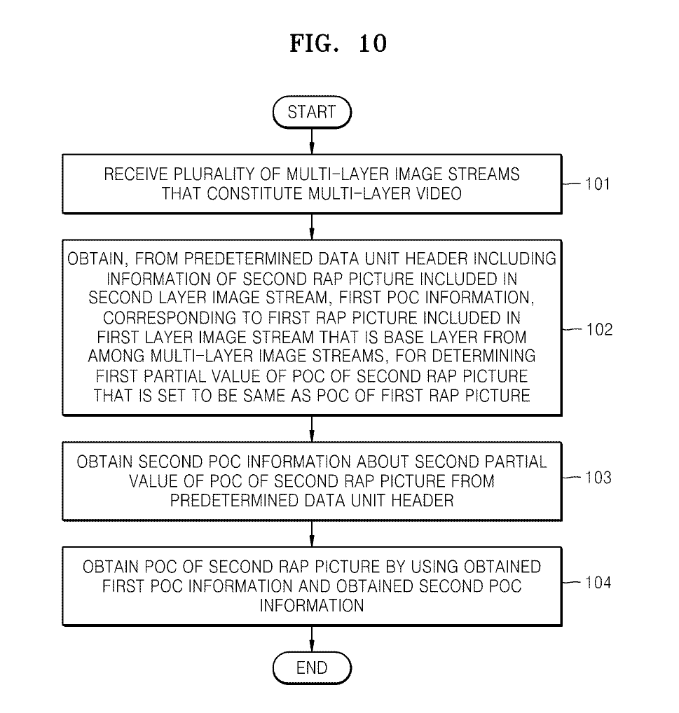

FIG. 10 is a flowchart illustrating a multi-layer video decoding method according to an exemplary embodiment.

Referring to FIGS. 9 and 10, in operation 101, the receiver 91 receives a plurality of multi-layer image streams that constitute a multi-layer video.

In operation 102, the receiver 92 obtains first POC information for determining a first partial value of a POC of a second RAP picture that is set to be the same as a POC of a first RAP picture, from a predetermined data unit header including information of the second RAP picture that corresponds to the first RAP picture included in a first layer image stream, which is a base layer from among multi-layer image streams, and is included in a second layer image stream. As described above, a RAP picture may be a CRA picture or a BLA picture, and the data unit header may be one selected from a slice header, an SPS, a PPS, and an APS. Also, when a binary value corresponding to the POC of the second RAP picture includes m upper bits and n lower bits, the first POC information that is information for determining MSBs of the POC may be information about the m upper bits. When the second RAP picture is displayed at a x*(2̂n)th numerical position (x is an integer) or a {(x+1)*(2̂n)−1}th numerical position based on an IDR picture, the first POC information may be a value of x indicating a number of repetitions of one cycle.

In operation 103, the receiver 92 obtains second POC information about a second partial value of the POC of the second RAP picture from the predetermined data unit header. As described above, the second POC information may be LSBs of the POC of the second RAP picture.

In operation 104, the receiver 92 obtains the POC of the second RAP picture by using the obtained first POC information and the obtained second POC information. When information about the MSBs and the LSBs of the POC of the second RAP picture is obtained through MSBs+LSBs, the receiver 910 may restore the POC of the second RAP picture.

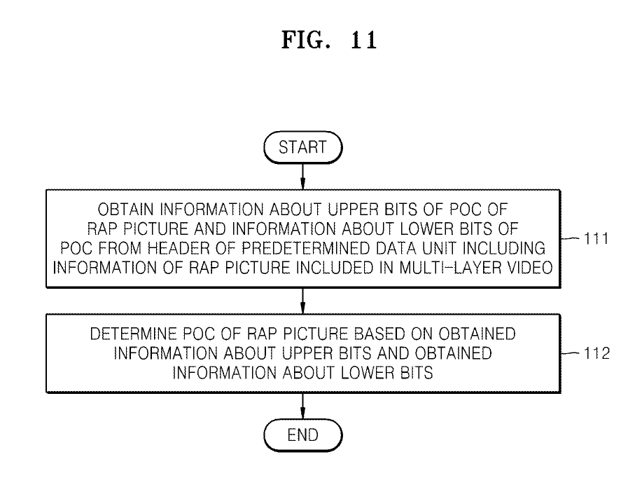

FIG. 11 is a flowchart illustrating a method of determining an image order of a multi-layer video, according to an exemplary embodiment.

Referring to FIG. 11, in operation 111, the receiver 92 obtains, from a header of a predetermined data unit including information of a RAP picture that is included in the multi-layer video, information about MSBs that are upper bits of a POC of the RAP picture and LSBs that are lower bits of the POC. The RAP picture may be a CRA picture or a BLA picture. The header of the predetermined data unit may be one selected from a slice header, an SPS, a PPS, and an APS. The header of the predetermined data unit including the information of the RAP picture may be received through a NAL unit having a predetermined identifier.

In operation 112, when the information about the MSBs and the LSBs of the RAP picture is obtained, the receiver 92 may restore the POC of the RAP picture through MSBs+LSBs.

The multi-layer video encoding apparatus 20 according to an exemplary embodiment and the multi-layer video decoding apparatus 90 according to an exemplary embodiment may encode or decode an image of each layer by using coding units having a hierarchical tree structure. A video encoding method and apparatus and a video decoding method and apparatus to perform encoding and decoding operations based on coding units having a tree structure according to an exemplary embodiment will be explained with reference to FIGS. 12 through 24. The following video encoding method using coding units having a tree structure may apply to video encoding of one layer that is performed by one from among the n layer encoders 22 and 23 included in the multi-layer encoder 21 of the multi-layer video encoding apparatus 20 of FIG. 2. Also, the following video decoding method and apparatus may apply to video decoding of one layer that is performed by one from among the n layer decoders 93 and 94 included in the multi-layer decoder 92 of the multi-layer video decoding apparatus 90 of FIG. 9.

A video encoding method and apparatus that performs prediction encoding on a prediction unit and a partition based on coding units having a tree structure and a video decoding method and apparatus that performs prediction decoding will now be explained in detail with reference to FIGS. 12 through 24.

FIG. 12 is a block diagram of a video encoding apparatus 100 that performs video prediction based on coding units having a tree structure, according to an exemplary embodiment.

The video encoding apparatus 100 that performs video prediction based on coding units having a tree structure according to an exemplary embodiment includes a maximum coding unit splitter 110, a coding unit determiner 120, and an output unit 130. For convenience of explanation, the video encoding apparatus 100 that performs video prediction based on coding units having a tree structure according to an exemplary embodiment may simply be referred to as ‘video encoding apparatus 100’.

The maximum coding unit splitter 110 may split a current picture based on a maximum coding unit that is a coding unit having a maximum size for the current picture of an image. If the current picture is larger than the maximum coding unit, image data of the current picture may be split into the at least one maximum coding unit. The maximum coding unit according to an exemplary embodiment may be a data unit having a size of 32×32, 64×64, 128×128, or 256×256, wherein a shape of the data unit is a square having a width and length in squares of 2. The image data may be output to the coding unit determiner 120 according to the at least one maximum coding unit.

A coding unit according to an exemplary embodiment may be characterized by a maximum size and a depth. The depth denotes a number of times the coding unit is spatially split from the maximum coding unit, and as the depth increases, deeper coding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit increases, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an exemplary embodiment is split according to depths, the image data of a spatial domain included in the maximum coding unit may be hierarchically classified according to depths.

A maximum depth and a maximum size of a coding unit, which limit a total number of times a height and a width of the maximum coding unit are hierarchically split, may be previously set.

The coding unit determiner 120 encodes at least one split region obtained by splitting a region of the maximum coding unit according to depths, and determines a depth to output final encoding results according to the at least one split region. In other words, the coding unit determiner 120 determines a coded depth by encoding the image data in the deeper coding units according to depths, according to the maximum coding unit of the current picture, and selecting a depth having a least encoding error. The determined coded depth and the image data according to the maximum coding unit are output to the output unit 130.

The image data in the maximum coding unit is encoded based on the deeper coding units corresponding to at least one depth equal to or less than the maximum depth, and encoding results are compared based on each of the deeper coding units. A depth having the least encoding error may be selected after comparing encoding errors of the deeper coding units. At least one coded depth may be selected for each maximum coding unit.

A size of the maximum coding unit is split as a coding unit is hierarchically split according to depths, and a number of coding units increases. Also, even if coding units correspond to the same depth in one maximum coding unit, it is determined whether to split each of the coding units corresponding to the same depth to a lower depth by measuring an encoding error of the data of each coding unit, separately. Accordingly, even when data is included in one maximum coding unit, the encoding errors according to depths may differ according to regions, and thus the coded depths may differ according to regions. Thus, one or more coded depths may be set for one maximum coding unit, and the data of the maximum coding unit may be divided according to coding units of the one or more coded depths.

Accordingly, the coding unit determiner 120 according to an exemplary embodiment may determine coding units having a tree structure included in a current maximum coding unit. The ‘coding units having a tree structure’ according to an exemplary embodiment include coding units corresponding to a depth determined to be a coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an exemplary embodiment is an index related to a number of times splitting is performed from a maximum coding unit to a minimum coding unit. A first maximum depth according to an exemplary embodiment may denote a total number of times splitting is performed from the maximum coding unit to the minimum coding unit. A second maximum depth according to an exemplary embodiment may denote a total number of depth levels from the maximum coding unit to the minimum coding unit. For example, when a depth of the maximum coding unit is 0, a depth of a coding unit in which the maximum coding unit is split once may be set to 1, and a depth of a coding unit in which the maximum coding unit is split twice may be set to 2. In this case, if the minimum coding unit is a coding unit obtained by splitting the maximum coding unit four times, 5 depth levels of depths 0, 1, 2, 3 and 4 exist, and thus the first maximum depth may be set to 4 and the second maximum depth may be set to 5.

Prediction encoding and transformation may be performed according to the maximum coding unit. The prediction encoding and the transformation are also performed based on the deeper coding units according to a depth equal to or depths less than the maximum depth, according to the maximum coding unit.

Since a number of deeper coding units increases whenever the maximum coding unit is split according to depths, encoding including the prediction encoding and the transformation has to be performed on all of the deeper coding units generated as the depth increases. For convenience of explanation, the prediction encoding and the transformation will now be described based on a coding unit of a current depth, from among at least one maximum coding unit.

The video encoding apparatus 100 according to an exemplary embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the maximum coding unit, the prediction encoding may be performed based on a coding unit corresponding to a coded depth, e.g., based on a coding unit that is no longer split into coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit.

For example, when a coding unit of 2N×2N (where N is a positive integer) is no longer split, the coding unit may become a prediction unit of 2N×2N and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, an inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 according to an exemplary embodiment may also perform the transformation on the image data in a coding unit based not only on the coding unit for encoding the image data but also based on a data unit that is different from the coding unit. In order to perform the transformation in the coding unit, the transformation may be performed based on a data unit having a size smaller than or equal to the coding unit. For example, the data unit for the transformation may include a data unit for an intra mode and a transformation unit for an inter mode.

Similarly to the coding unit, the transformation unit in the coding unit may be recursively split into smaller sized transformation units, and thus, residual data in the coding unit may be divided according to the transformation unit having a tree structure according to transformation depths.

A transformation depth indicating a number of times splitting is performed to reach the transformation unit by splitting the height and width of the coding unit may also be set in the transformation unit according to an exemplary embodiment. For example, in a current coding unit of 2N×2N, a transformation depth may be 0 when the size of a transformation unit is 2N×2N, may be 1 when the size of a transformation unit is N×N, and may be 2 when the size of a transformation unit is N/2×N/2. That is, the transformation unit having the tree structure may also be set according to transformation depths.

Encoding information according to coding units corresponding to a coded depth requires not only information about the coded depth but also about information related to prediction encoding and transformation. Accordingly, the coding unit determiner 120 not only determines a coded depth having a least encoding error but also determines a partition type in a prediction unit, a prediction mode according to prediction units, and a size of a transformation unit for transformation.

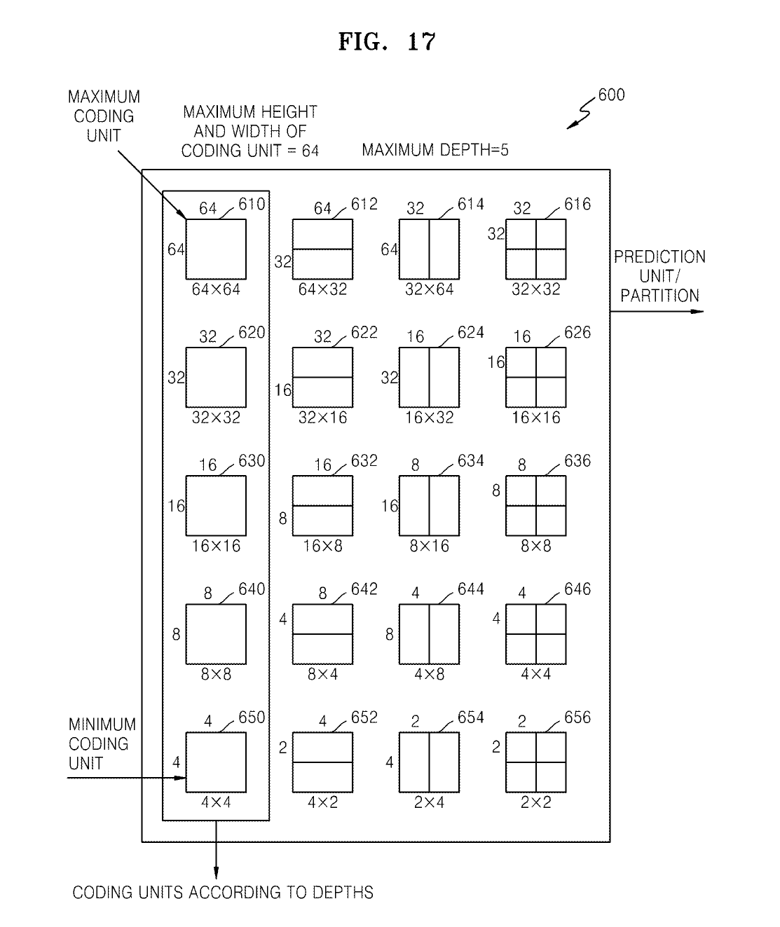

Coding units having a tree structure in a maximum coding unit and a method of determining a partition according to an exemplary embodiment will be explained in detail below with reference to FIGS. 17 through 24.

The coding unit determiner 120 may measure an encoding error of deeper coding units according to depths by using Rate-Distortion (RD) Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to coded depths may include information about the coded depth, the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, the encoding is performed on the current coding unit of the current depth, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit and information about at least one encoding mode is determined for a coding unit of a coded depth, information about at least one encoding mode may be determined for one maximum coding unit. Also, a coded depth of the data of the maximum coding unit may be different according to locations since the data is hierarchically split according to depths, and thus information about the coded depth and the encoding mode may be set for the data.

Accordingly, the output unit 130 according to an exemplary embodiment may assign encoding information about a corresponding coded depth and an encoding mode to at least one of the coding unit, the prediction unit, and a minimum unit included in the maximum coding unit.

The minimum unit according to an exemplary embodiment is a rectangular data unit obtained by splitting the minimum coding unit constituting a lowermost depth by 4. Alternatively, the minimum unit may be a maximum rectangular data unit that may be included in all of the coding units, prediction units, partition units, and transformation units included in the maximum coding unit.

For example, the encoding information output through the output unit 130 may be classified into encoding information according to deeper coding units according to depths, and encoding information according to prediction units. The encoding information according to the deeper coding units according to depths may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream.

Also, information about a maximum size of a transformation unit and information of a minimum size of a transformation unit that are allowed for a current video may also be output through a header of a bitstream, an SPS, or a PPS. The output unit 130 may encode and output information about scalability of a coding unit with reference to FIGS. 5 through 8.

In the video encoding apparatus 100 according to a simplest exemplary embodiment, the deeper coding unit is a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include a maximum number of 4 coding units of the lower depth.

Accordingly, the video encoding apparatus 100 according to an exemplary embodiment may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering image characteristics of the coding unit of various image sizes.

Thus, if an image having high resolution or a large data amount is encoded in a related art macroblock, a number of macroblocks per picture excessively increases. Accordingly, a number of pieces of compressed information generated for each macroblock increases, and thus it is difficult to transmit the compressed information and data compression efficiency decreases. However, by using the video encoding apparatus 100 according to an exemplary embodiment, image compression efficiency may be increased since a coding unit is adjusted while considering characteristics of an image while increasing a maximum size of a coding unit while considering a size of the image.

FIG. 13 is a block diagram of a video decoding apparatus 200 that performs video prediction based on coding units having a tree structure, according to an exemplary embodiment.

The video decoding apparatus 200 that performs video prediction based on coding units having a tree structure according to an exemplary embodiment includes a receiver 210, an image data and encoding information extractor 220, and an image data decoder 230. For convenience of explanation, the video decoding apparatus 200 that performs video prediction based on coding units having a tree structure according to an exemplary embodiment may simply be referred to as ‘video decoding apparatus 200’.

Definitions of various terms, such as a coding unit, a depth, a prediction unit, a transformation unit, and information about various encoding modes, for various operations of the video decoding apparatus 200 according to an exemplary embodiment may be identical to those described with reference to FIG. 12 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture.

Also, the image data and encoding information extractor 220 extracts information about a coded depth and an encoding mode for the coding units having the tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coded depth, and information about an encoding mode according to each coded depth may include information about a partition type of a corresponding coding unit corresponding to the coded depth, a prediction mode, and a size of a transformation unit. Also, split information according to depths may be extracted as the information about the coded depth.

The information about the coded depth and the encoding mode according to each maximum coding unit extracted by the image data and encoding information extractor 220 is information about a coded depth and an encoding mode determined to generate a least encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to an encoding mode that generates the least encoding error.

Since encoding information about the coded depth and the encoding mode according to an exemplary embodiment may be assigned to a predetermined data unit from among a corresponding coding unit, a prediction unit, and a minimum unit, the image data and encoding information extractor 220 may extract the information about the coded depth and the encoding mode according to the predetermined data units. When the information about the coded depth of the corresponding maximum coding unit and the encoding mode is recorded according to the predetermined data units, the predetermined data units having the same information about the coded depth and the encoding mode may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include prediction including intra prediction and motion compensation, and inverse transformation.

The image data decoder 230 may perform intra prediction or motion compensation according to a partition and a prediction mode of each coding unit, based on the information about the partition type and the prediction mode of the prediction unit of the coding unit according to coded depths.

Also, the image data decoder 230 may perform inverse transformation according to each transformation unit in the coding unit, based on the information about the size of the transformation unit of the coding unit according to coded depths, so as to perform the inverse transformation according to maximum coding units.

The image data decoder 230 may determine a coded depth of a current maximum coding unit by using split information according to depths. If the split information indicates that image data is no longer split in the current depth, the current depth is a coded depth. Accordingly, the image data decoder 230 may decode encoded data of the current depth by using the information about the partition type of the prediction unit, the prediction mode, and the size of the transformation unit for image data of the current maximum coding unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode.

The video decoding apparatus 200 may obtain information about a coding unit that generates the least encoding error when encoding is recursively performed for each maximum coding unit, and may use the information to decode the current picture. In other words, the coding units having the tree structure determined to be the optimum coding units in each maximum coding unit may be decoded.

Accordingly, even if image data has high resolution and a large amount of data, the image data may be efficiently decoded and restored according to a size of a coding unit and an encoding mode, which are adaptively determined according to characteristics of an image, by using information about an optimum encoding mode received from an encoder.

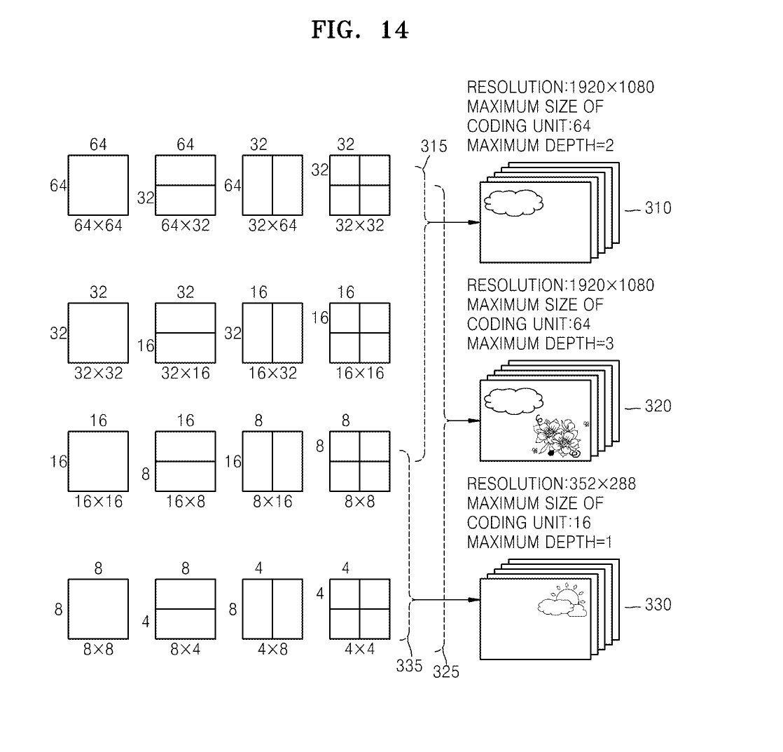

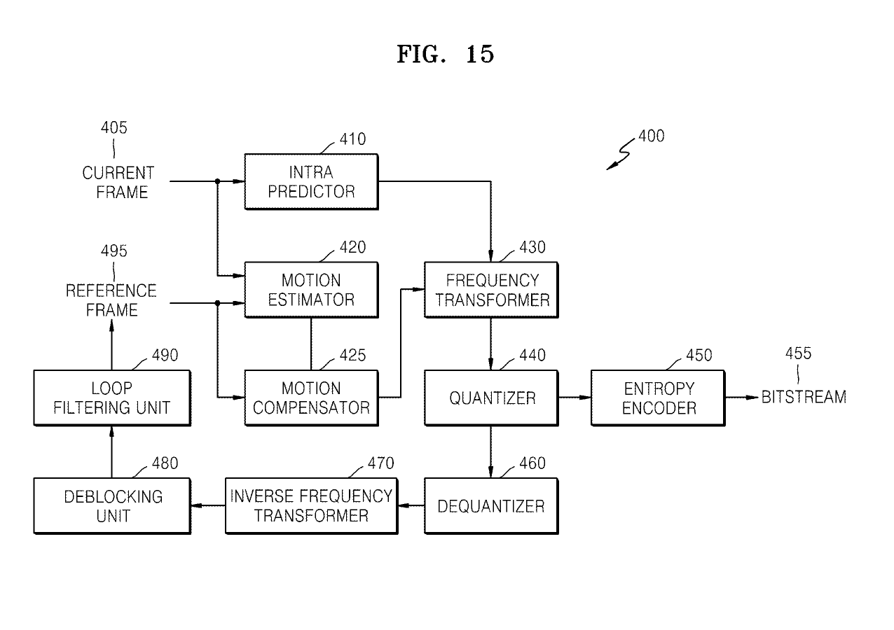

FIG. 14 is a diagram for explaining a concept of coding units according to an exemplary embodiment.

A size of a coding unit may be expressed in width×height, and examples of the size of the coding unit may include 64×64, 32×32, 16×16, and 8×8. A coding unit of 64×64 may be split into partitions of 64×64, 64×32, 32×64, or 32×32, a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is set to 1920×1080, a maximum size of a coding unit is set to 64, and a maximum depth is set to 2. In video data 320, a resolution is set to 1920×1080, a maximum size of a coding unit is set to 64, and a maximum depth is set to 3. In video data 330, a resolution is set to 352×288, a maximum size of a coding unit is set to 16, and a maximum depth is set to 1. The maximum depth shown in FIG. 3 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the video data 310 may include a maximum coding unit having a long axis size of 64, and coding units having long axis sizes of 32 and 16 since depths are increased to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are increased to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are increased to 3 layers by splitting the maximum coding unit three times. As a depth increases, detailed information may be more precisely expressed.

FIG. 15 is a block diagram of an image encoder 400 configured to perform an encoding operation based on coding units, according to an exemplary embodiment.

The image encoder 400 according to an exemplary embodiment performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 perform inter estimation and motion compensation on coding units in an inter mode from among the current frame 405 by using the current frame 405 and a reference frame 495.

Data output from the intra predictor 410, the motion estimator 420, and the motion compensator 425 is output as a quantized transformation coefficient through a frequency transformer 430 and a quantizer 440. The quantized transformation coefficient is restored as data in a spatial domain through a dequantizer 460 (e.g., inverse quantizer) and an inverse frequency transformer 470, and the restored data in the spatial domain is output as the reference frame 495 after being post-processed through a deblocking unit 480 and a loop filtering unit 490. The quantized transformation coefficient may be output as a bitstream 455 through an entropy encoder 450.

In order for the image encoder 400 to be implemented in the video encoding apparatus 100 according to an exemplary embodiment, all elements of the image encoder 400, e.g., the intra predictor 410, the motion estimator 420, the motion compensator 425, the frequency transformer 430, the quantizer 440, the entropy encoder 450, the dequantizer 460, the inverse frequency transformer 470, the deblocking unit 480, and the loop filtering unit 490, have to perform operations based on each coding unit from among coding units having a tree structure while considering the maximum depth of each maximum coding unit.

Specifically, the intra predictor 410, the motion estimator 420, and the motion compensator 425 have to determine partitions and a prediction mode of each coding unit from among the coding units having the tree structure while considering the maximum size and the maximum depth of a current maximum coding unit, and the frequency transformer 430 has to determine the size of the transformation unit in each coding unit from among the coding units having the tree structure.

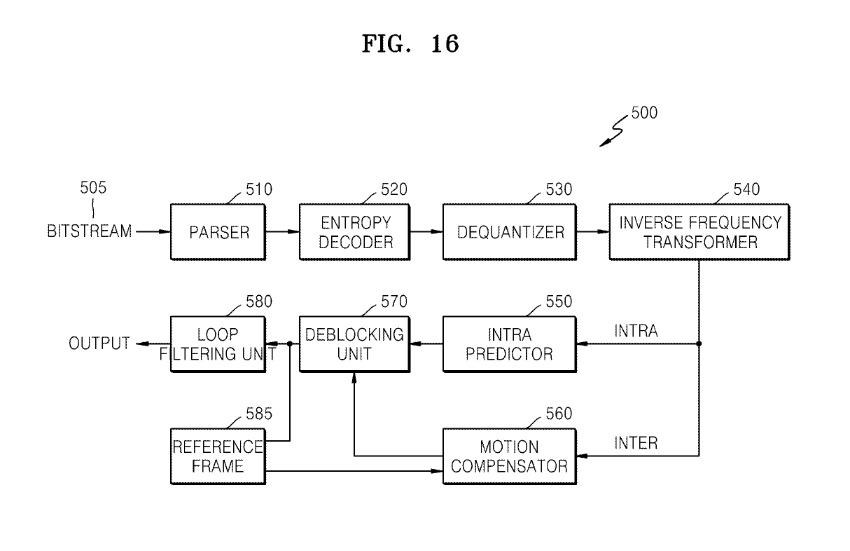

FIG. 16 is a block diagram of an image decoder 500 configured to perform a decoding operation based on coding units, according to an exemplary embodiment.

A parser 510 parses encoded image data to be decoded and information about encoding required for decoding from a bitstream 505. The encoded image data is output as inverse quantized data through an entropy decoder 520 and a dequantizer 530 (e.g., inverse quantizer), and the inverse quantized data is restored to image data in a spatial domain through an inverse frequency transformer 540.

An intra predictor 550 performs intra prediction on coding units in an intra mode with respect to the image data in the spatial domain, and a motion compensator 560 performs motion compensation on coding units in an inter mode by using a reference frame 585.

The data in the spatial domain, which passed through the intra predictor 550 and the motion compensator 560, may be output as a restored frame after being post-processed through a deblocking unit 570 and a loop filtering unit 580. Also, the data, which is post-processed through the deblocking unit 570 and the loop filtering unit 580, may be output as the reference frame 585.

In order to decode the image data in the image data decoder 230 of the video decoding apparatus 200, the image decoder 500 may perform operations that are performed after operations of the parser 510 are performed.

In order for the image decoder 500 to be implemented in the video decoding apparatus 200 according to an exemplary embodiment, all elements of the image decoder 500, e.g., the parser 510, the entropy decoder 520, the dequantizer 530, the inverse frequency transformer 540, the intra predictor 550, the motion compensator 560, the deblocking unit 570, and the loop filtering unit 580, have to perform operations based on coding units having a tree structure for each maximum coding unit.

Specifically, the intra predictor 550 and the motion compensator 560 have to determine partitions and a prediction mode for each of the coding units having the tree structure, and the inverse frequency transformer 540 has to determine a size of a transformation unit for each coding unit.

FIG. 17 is a diagram illustrating deeper coding units according to depths and partitions, according to an exemplary embodiment.

The video encoding apparatus 100 according to an exemplary embodiment and the video decoding apparatus 200 according to an exemplary embodiment use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the maximum size of the coding unit which is previously set.

In a hierarchical structure 600 of coding units according to an exemplary embodiment, the maximum height and the maximum width of the coding units are each 64, and the maximum depth is 4. Since a depth increases along a vertical axis of the hierarchical structure 600 of the coding units according to an exemplary embodiment, a height and a width of the deeper coding unit are each split. Also, a prediction unit and partitions, which are bases for prediction encoding of each deeper coding unit, are shown along a horizontal axis of the hierarchical structure 600 of the coding units.

In other words, a coding unit 610 is a maximum coding unit in the hierarchical structure 600 of the coding units, wherein a depth is 0 and a size, e.g., a height by width, is 64×64. The depth increases along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions included in the coding unit 610, e.g., a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, e.g., a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, e.g., a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, e.g., a partition having a size of 8×8 included in the coding unit 640, partitions 642 having a size of 8×4, partitions 644 having a size of 4×8, and partitions 646 having a size of 4×4.

Finally, the coding unit 650 having the size of 4×4 and the depth of 4 is the minimum coding unit and a coding unit of a lowermost depth. A prediction unit of the coding unit 650 is only assigned to a partition having a size of 4×4.

In order to determine a coded depth of the maximum coding unit 610, the coding unit determiner 120 of the video encoding apparatus 100 according to an exemplary embodiment has to perform encoding for coding units corresponding to each depth included in the maximum coding unit 610.

A number of deeper coding units according to depths including data in the same range and the same size increases as the depth increases. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 have to be each encoded.

In order to perform encoding according to each depth, a representative encoding error that is a least encoding error in the corresponding depth may be selected by performing encoding for each prediction unit in the deeper coding units, along the horizontal axis of the hierarchical structure 600 of the coding units. Alternatively, the least encoding error may be searched for by comparing representative encoding errors according to depths by performing encoding for each depth as the depth increases along the vertical axis of the hierarchical structure 600 of the coding units. A depth and a partition having the least encoding error in the maximum coding unit 610 may be selected as the coded depth and a partition type of the maximum coding unit 610.

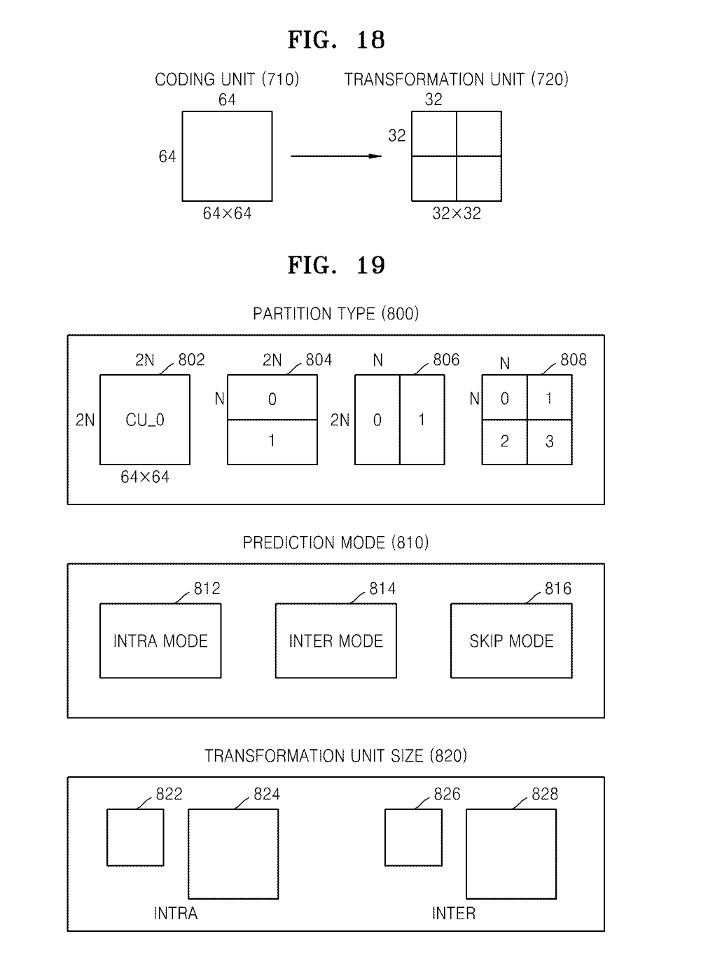

FIG. 18 is a diagram for explaining a relationship between a coding unit 710 and transformation units 720, according to an exemplary embodiment.

The video encoding apparatus 100 according to an exemplary embodiment or the video decoding apparatus 200 according to an exemplary embodiment encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 according to an exemplary embodiment or the video decoding apparatus 200 according to an exemplary embodiment, if a size of the current coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having a least error may be selected.

FIG. 19 is a diagram for explaining encoding information of coding units corresponding to a coded depth, according to an exemplary embodiment.

The output unit 130 of the video encoding apparatus 100 according to an exemplary embodiment may encode and transmit information 800 about a partition type, information 810 about a prediction mode, and information 820 about a size of a transformation unit for each coding unit corresponding to a coded depth, as information about an encoding mode.

The information 800 about the partition type indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about the partition type of the current coding unit is set to indicate one of the partition 804 having a size of 2N×N, the partition 806 having a size of N×2N, and the partition 808 having a size of N×N

The information 810 about the prediction mode indicates a prediction mode of each partition. For example, the information 810 about the prediction mode may indicate a mode of prediction encoding performed on a partition indicated by the information 800, e.g., an intra mode 812, an inter mode 814, or a skip mode 816.

Also, the information 820 about the size of the transformation unit indicates a transformation unit to be based on when transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 according to an exemplary embodiment may extract and use the information 800 about the partition type, the information 810 about the prediction mode, and the information 820 about the size of the transformation unit for decoding according to each deeper coding unit

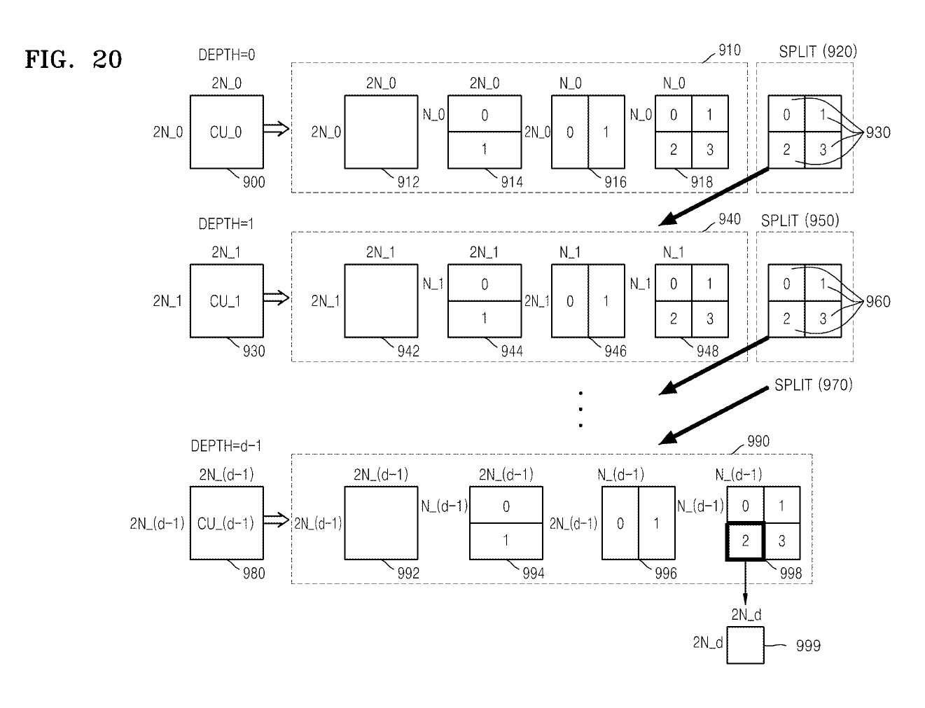

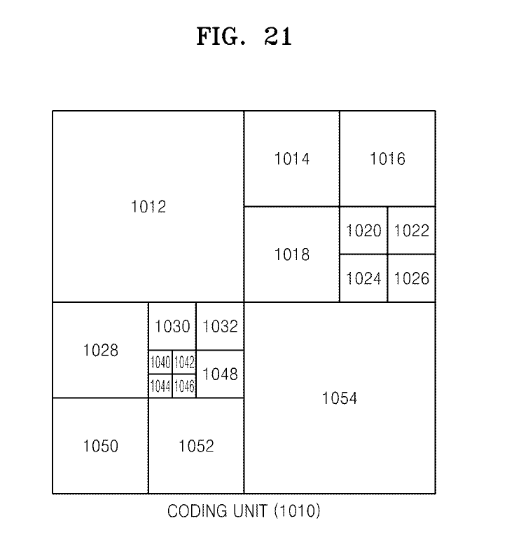

FIG. 20 is a diagram of deeper coding units according to depths according to an exemplary embodiment.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding has to be repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N 0×N_{—}0, and N 0×N_{—}0. The prediction encoding in a skip mode may be performed only on the partition having the size of 2N_{—}0×2N_{—}0.

If an encoding error is smallest in one of the partition types 912 through 916 having the sizes of 2N_{—}0×2N_{—}0, 2N_{—}0×N_{—}0, and N_{—}0×2N_{—}0, the prediction unit 910 may be no longer split to a lower depth.

If the encoding error is the smallest in the partition type 918 having the size of N_{—}0×N_{—}0, a depth may be changed from 0 to 1 to split the partition type 918 in operation 920, and encoding may be repeatedly performed on coding units 930 having a depth of 2 and a size of N_{—}0×N_{—}0 to search for a least encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948 having the size of N_{—}1×N_{—}1, a depth may be changed from 1 to 2 to split the partition type 948 in operation 950, and encoding may be repeatedly performed on coding units 960, which have a depth of 2 and a size of N_{—}2×N_{—}2 to search for a least encoding error.

When a maximum depth is d, split information according to each depth may be set until a depth becomes d−1, and split information may be set until a depth becomes d−2. In other words, when encoding is performed until the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a least encoding error.

Even when the partition type 998 having the size of N_(d−1)×N_(d−1) has the least encoding error, since a maximum depth is d, a coding unit CU_(d−1) having a depth of d−1 may be no longer split to a lower depth, a coded depth for a current maximum coding unit 900 may be determined to be d−1, and a partition type of the current maximum coding unit 900 may be determined to be N_(d−1)×N_(d−1). Also, since the maximum depth is d, split information for a coding unit 992 having a depth of d−1 is not set.

A data unit 999 may be referred to as a ‘minimum unit’ for the current maximum coding unit. A minimum unit according to an exemplary embodiment may be a rectangular data unit obtained by splitting a minimum coding unit having a lowermost coded depth by 4. By performing the encoding repeatedly, the video encoding apparatus 100 according to an exemplary embodiment may select a depth having a least encoding error by comparing encoding errors according to depths of the coding unit 900 to determine a coded depth, and may set a corresponding partition type and a prediction mode as an encoding mode of the coded depth.

As such, the least encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit has to be split from a depth of 0 to the coded depth, only split information of the coded depth has to be set to ‘0’, and split information of depths excluding the coded depth has to be set to ‘1’.

The image data and encoding information extractor 220 of the video decoding apparatus 200 according to an exemplary embodiment may extract and use the information about the coded depth and the prediction unit of the coding unit 900 to decode the coding unit 912. The video decoding apparatus 200 according to an exemplary embodiment may determine a depth, in which split information is ‘0’, as a coded depth by using split information according to depths, and may use information about an encoding mode of the corresponding depth for decoding.

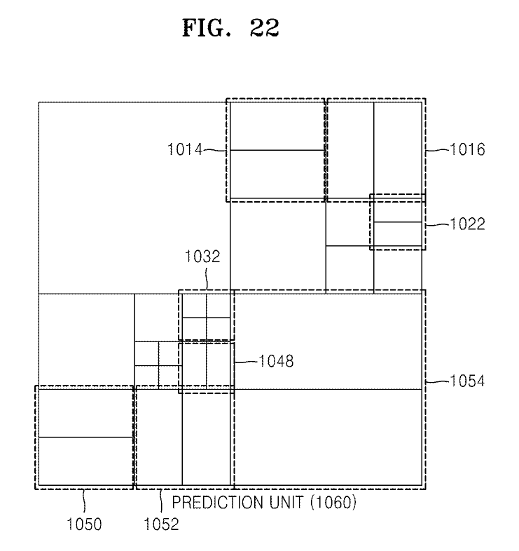

FIGS. 21, 22, and 23 are diagrams for explaining a relationship between coding units 1010, prediction units 1060, and transformation units 1070, according to an exemplary embodiment.

The coding units 1010 are coding units corresponding to coded depths determined by the video encoding apparatus 100 according to an exemplary embodiment, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some partitions 1014, 1016, 1022, 1032, 1048, 1050, 1052, and 1054 are obtained by splitting the coding units. In other words, partition types in the partitions 1014, 1022, 1050, and 1054 have a size of 2N×N, partition types in the partitions 1016, 1048, and 1052 have a size of N×2N, and a partition type of the partition 1032 has a size of N×N. Prediction units and partitions of the coding units 1010 are smaller than or equal to each coding unit.

Transformation or inverse transformation is performed on image data of the transformation unit 1052 in the transformation units 1070 in a data unit that is smaller than the transformation unit 1052. Also, the transformation units 1014, 1016, 1022, 1032, 1048, 1050, 1052, and 1054 in the transformation units 1070 are different from those in the prediction units 1060 in terms of sizes or shapes. In other words, the video encoding apparatus 100 according to an exemplary embodiment and the video decoding apparatus 200 according to an exemplary embodiment may perform intra prediction, motion estimation or motion compensation, and transformation or inverse transformation individually on a data unit even in the same coding unit.

Accordingly, encoding may be recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding apparatus 100 according to an exemplary embodiment and the video decoding apparatus 200 according to an exemplary embodiment.

TABLE 1

| Split Information 0 | | | | | Split |
|---|---|---|---|---|---|
| (Encoding on Coding Unit having Size of 2N × 2N and Current Depth of d) | | | | | Information 1 |
| Prediction | Partition Type | | Size of Transformation Unit | | Repeatedly |
| Mode | | | | | Encode |
| Intra | Symmetrical | Asymmetrical | Split | Split | Coding Units |
| Inter | Partition | Partition | Information 0 of | Information 1 of | having |
| Skip | Type | Type | Transformation | Transformation | Lower Depth |
| (Only | | | Unit | Unit | of d + 1 |
| 2N × 2N) | 2N × 2N | 2N × nU | 2N × 2N | N × N | |
| | 2N × N | 2N × nD | | (Symmetrical | |
| | N × 2N | nL × 2N | | Type) | |
| | N × N | nR × 2N | | N/2 × N/2 | |
| | | | | (Asymmetrical | |
| | | | | Type) | |

The output unit 130 of the video encoding apparatus 100 according to an exemplary embodiment may output the encoding information about the coding units having the tree structure, and the image data and encoding information extractor 220 of the video decoding apparatus 200 according to an exemplary embodiment may extract the encoding information about the coding units having the tree structure from a received bitstream.

Split information indicates whether a current coding unit is split into coding units of a lower depth. If split information of a current depth d is 0, a depth, in which a current coding unit is no longer split to a lower depth, is a coded depth, and thus information about a partition type, a prediction mode, and a size of a transformation unit may be defined for the coded depth. If the current coding unit is further split according to the split information, encoding has to be independently performed on four split coding units of a lower depth.

A prediction mode may be one of an intra mode, an inter mode, and a skip mode. The intra mode and the inter mode may be defined in all partition types, and the skip mode may be defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD are respectively obtained by splitting the height of the prediction unit in 1:3 and 3:1, and the asymmetrical partition types having the sizes of nL×2N and nR×2N are respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit is set to 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be set to N×N, and if the partition type of the current coding unit is an asymmetrical partition type, the size of the transformation unit may be set to N/2×N/2.

The encoding information about coding units having a tree structure according to an exemplary embodiment may be assigned to at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth may be determined by using encoding information of a data unit, and thus a distribution of coded depths in a maximum coding unit may be determined.

Accordingly, if a current coding unit is predicted by referring to adjacent data units, encoding information of data units in deeper coding units adjacent to the current coding unit may be directly referred to and used.

Alternatively, if a current coding unit is prediction encoded by referring to adjacent data units, data units adjacent to the current coding unit in deeper coding units may be searched for by using encoding information of the data units, and the searched adjacent coding units may be referred to for prediction encoding the current coding unit.

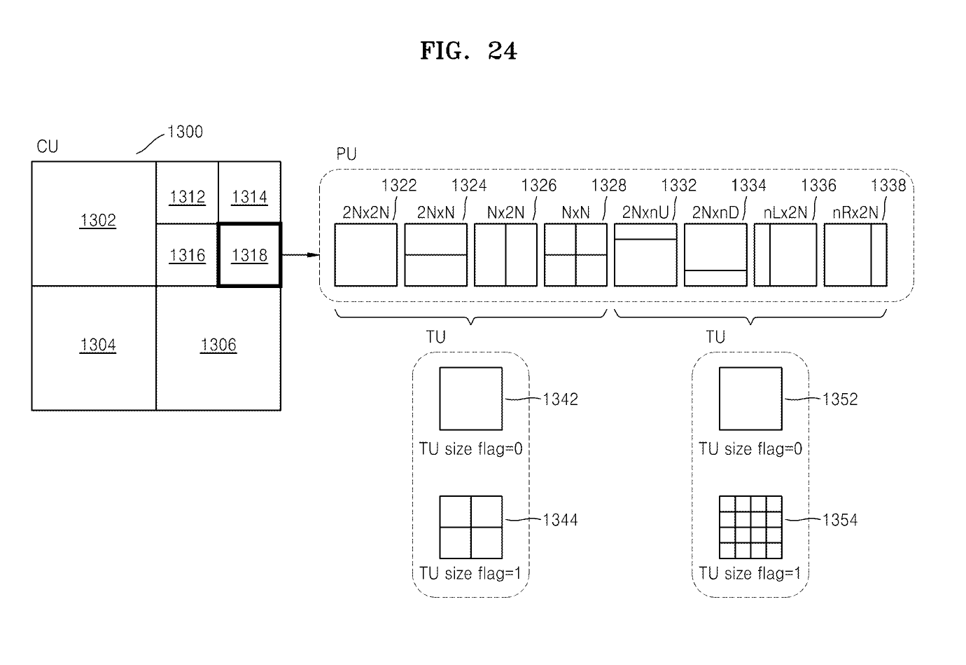

FIG. 24 is a diagram for explaining a relationship between a coding unit, a prediction unit, and a transformation unit, according to the encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Transformation unit split information (TU size flag) may be a transformation index, and a size of a transformation unit corresponding to the transformation index may vary according to a prediction unit type or a partition type of a coding unit.

When the partition type is set to be symmetrical, e.g., the partition type 1322 having the size of 2N×2N, 1324 having the size of 2N×N, 1326 having the size of N×2N, or 1328 having the size of N×N, a transformation unit 1342 having a size of 2N×2N may be set if a TU size flag of a transformation unit is 0, and a transformation unit 1344 having a size of N×N may be set if a TU size flag is 1.

When the partition type is set to be asymmetrical, e.g., the partition type 1332 having the size of 2N×nU, 1334 having the size of 2N×nD, 1336 having the size of nL×2N, or 1338 having the size of nR×2N, a transformation unit 1352 having a size of 2N×2N may be set if a TU size flag is 0, and a transformation unit 1354 having a size of N/2×N/2 may be set if a TU size flag is 1.

The exemplary embodiments may be embodied as computer-readable codes in a computer-readable recording medium. The computer-readable recording medium includes any storage device that may store data which may be read by a computer system. Examples of the computer-readable recording medium include read-only memories (ROMs), random-access memories (RAMs), CD-ROMs, magnetic tapes, floppy disks, and optical data storage devices. The computer-readable recording medium may be distributed over network-coupled computer systems so that the computer-readable codes are stored and executed in a distributed fashion

While the exemplary embodiments have been particularly shown and described with reference to certain exemplary embodiments thereof using specific terms, the exemplary embodiments and terms have been used to explain the exemplary embodiments and should not be construed as limiting the scope of the exemplary embodiments defined by the claims. Accordingly, it will be understood by those of ordinary skill in the art that various changes in form and details may be made therein without departing from the spirit and scope of the exemplary embodiments as defined by the following claims.

1. A multi-layer video decoding method comprising:
receiving a plurality of multi-layer image streams that constitute a multi-layer video;
obtaining, from a data unit header comprising information of a second random access point (RAP) picture that corresponds to a first RAP picture included in a first layer image stream, which is a base layer from among the plurality of multi-layer image streams, and is included in a second layer image stream from among the plurality of multi-layer image streams, first picture order count (POC) information for determining a first partial value of a POC of the second RAP picture that is set to be the same as a POC of the first RAP picture;
obtaining, from the data unit header, second POC information about a second partial value of the POC of the second RAP picture; and
obtaining the POC of the second RAP picture by using the obtained first POC information and the obtained second POC information.

2. The multi-layer video decoding method of claim 1, wherein the POC of the first RAP picture indicates a display order of the first RAP picture based on a previous instantaneous decoding refresh (IDR) picture, and when a binary value corresponding to the POC of the first RAP picture comprises m (m is an integer) upper bits and n (n is an integer) lower bits, the first POC information is information about the m upper bits and the second POC information is information about the n lower bits.

3. The multi-layer video decoding method of claim 1, wherein the POC of the first RAP picture indicates a display order of the first RAP picture based on an instantaneous decoding refresh (IDR) picture that precedes the first RAP picture, and when a binary value corresponding to the POC of the first RAP picture comprises m (m is an integer) upper bits and n (n is an integer) lower bits and 2ⁿ orders that may be expressed by using the n lower bits are defined as one cycle, when the first RAP picture is displayed at a x*(2ⁿ)th numerical position (x is an integer) or a {(x+1)*(2ⁿ)−1}th numerical position based on the IDR picture, the first POC information is a value of x indicating a number of repetitions of the one cycle and the second POC information is information about the n lower bits.

4. The multi-layer video decoding method of claim 1, wherein the obtaining of the first POC information comprises obtaining, from the data unit header, a flag indicating whether the first POC information is to be used, and when the obtained flag indicates that the first POC information is to be used, obtaining the first POC information.

5. The multi-layer video decoding method of claim 1, wherein the first and second RAP pictures are each a clean random access (CRA) picture or a broken link access (BLA) picture.

6. The multi-layer video decoding method of claim 1, wherein the data unit header is one selected from a sequence parameter set (SPS), a picture parameter set (PPS), an adaptation parameter set (APS), and a slice header.

7. The multi-layer video decoding method of claim 1, further comprising determining whether a picture loss occurs in the plurality of multi-layer image streams by setting the POC of the first RAP picture that is obtained by using the first POC information and the second POC information obtained from the data unit header and a POC of an instantaneous decoding refresh (IDR picture that precedes the first RAP picture to 0, increasing the POC set to 0 by 1 for each picture that is displayed after a previous IDR picture, and comparing obtained POCs of the first RAP picture.

8. A multi-layer video decoding apparatus comprising:
a receiver configured to receive a plurality of multi-layer image streams that constitute a multi-layer video, obtain, from a data unit header comprising information of a second random access point (RAP) picture that corresponds to a first RAP picture included in a first layer image stream, which is a base layer from among the plurality of multi-layer image streams, and is included in a second layer image stream from among the plurality of multi-layer image streams, first picture order count (POC) information for determining a first partial value of a POC of the second RAP picture that is set to be the same as a POC of the first RAP picture and second POC information about a second partial value of the POC of the second RAP picture, and obtain the POC of the second RAP picture by using the obtained first POC information and the obtained second POC information; and
a multi-layer decoder configured to decode the plurality of multi-layer image streams.

9. A multi-layer video encoding method comprising:
encoding a plurality of multi-layer images that constitute a multi-layer video and generating a plurality of multi-layer image streams based on the encoded plurality of multi-layer images;
adding, to a data unit header comprising information of a second random access point (RAP) picture that corresponds to a first RAP picture included in a first layer image stream, which is a base layer from among the plurality of multi-layer image streams, and is included in a second layer image stream from among the plurality of multi-layer image streams, first picture order count (POC) information for determining a first partial value of a POC of the second RAP picture that is set to be the same as a POC of the first RAP picture; and
adding second POC information about a second partial value of the POC of the second RAP picture to the data unit header.

10. The multi-layer video encoding method of claim 9, wherein the POC of the first RAP picture indicates a display order of the first RAP picture based on an instantaneous decoding refresh (IDR) picture that precedes the first RAP picture, and when a binary value corresponding to the POC of the first RAP picture comprises m (m is an integer) upper bits and n (n is an integer) lower bits, the first POC information is information about the m upper bits and the second POC information is information about the n lower bits.

11. The multi-layer video encoding method of claim 9, wherein the POC of the first RAP picture indicates a display order of the first RAP picture based on an instantaneous decoding refresh (IDR) picture that precedes the first RAP picture, and when a binary value corresponding to the POC of the first RAP picture comprises m (m is an integer) upper bits and n (n is an integer) lower bits and 2ⁿ orders are defined as one cycle, when the first RAP picture is displayed at a x*(2ⁿ)th numerical position (x is an integer) or a {(x+1)*(2ⁿ)−1}th numerical position, the first POC information is a value of x indicating a number of repetitions of the one cycle and the second POC information is information about the n lower bits.

12. The multi-layer video encoding method of claim 9, wherein the first and second RAP pictures are each a clean random access (CRA) picture or a broken link access (BLA) picture.

13. The multi-layer video encoding method of claim 9, wherein the data unit header is one selected from a sequence parameter set (SPS), a picture parameter set (PPS), an adaptation parameter set (APS), and a slice header.

14. A multi-layer video encoding apparatus comprising:
a multi-layer image encoder configured to encode a plurality of multi-layer images that constitute a multi-layer video and generate a plurality of multi-layer image streams based on the encoded plurality of multi-layer images; and
an outputter configured to add first picture order count (POC) information for determining a first partial value of a POC of a second random access point (RAP) picture that is set to be the same as a POC of a first RAP picture to a data unit header comprising information of the second RAP picture that corresponds to the first RAP picture included in a first layer image stream, which is a base layer from among the plurality of multi-layer image streams, and is included in a second layer image stream from among the plurality of multi-layer image streams, and add second POC information about a second partial value of the second RAP picture to the data unit header.

15. A method of determining an image order of a multi-layer video, the method comprising:
obtaining, from a header of a data unit comprising information of a random access point (RAP) picture included in the multi-layer video, information about upper bits of a picture order count (POC) of the RAP picture and information about lower bits of the POC; and
determining the POC of the RAP picture based on the obtained information about the upper bits and the obtained information about the lower bits.
